(19) United States
(12) Patent Application Publication
(10) Pub. No.: US 2012/0306447 A1
(43) Pub. Date: Dec. 6, 2012

(54) APPARATUS FOR STABILIZING VOLTAGE OF ENERGY STORAGE

(76) Inventors: Young Hak Jeong, Gyeonggi-do (KR); Hong Seok Min, Gyeonggi-do (KR); Bae Kyun Kim, Gyeonggi-do (KR); Chan Yoon, Seoul (KR)

(21) Appl. No.: 13/461,481

(22) Filed: May 1, 2012

(30) Foreign Application Priority Data
May 31, 2011 (KR) 10-2011-0052097

(51) Int. Cl. H02J 7/00

(52) U.S. Cl. 320/116; 320/166; 320/167

(57) ABSTRACT

Disclosed herein is an apparatus for stabilizing voltage of an energy storage in which a plurality of unit cells are connected to each other in series, including: a bypass unit that is connected to the unit cell in parallel; and a controller that detects voltage of the unit cell and controls an operation of the bypass unit according to the detected voltage of the unit cell, wherein the bypass unit bypasses current flowing in the unit cell when the detected voltage of the unit cell is larger than predetermined reference voltage to generate the reusing voltage, whereby the voltage of each unit cell is stably equalized and reuses the voltage provided to the bypass path, thereby performing voltage equalization without loss.

### CROSS REFERENCE(S) TO RELATED APPLICATIONS

This application claims the benefit under 35 U.S.C. Section 119 of Korean Patent Application Serial No. 10-2011-0052097, entitled “Apparatus For Stabilizing Voltage Of Energy Storage” filed on May 31, 2011, which is hereby incorporated by reference in its entirety into this application.

### BACKGROUND OF THE INVENTION

1. Technical Field

The present invention relates to an apparatus for stabilizing voltage of energy storage, and more particularly, to an apparatus for stabilizing voltage of energy storage capable of stably controlling voltage of unit cell of a secondary battery or a capacitor.

2. Description of the Related Art

The stable supply of energy is an important factor in various electronic products such as information communication devices. Generally, this function is performed by a battery. Recently, as the spread of mobile devices is increased, the use of a secondary battery capable of supplying energy to the mobile devices by repeating charging/discharging several thousand times or tens of thousand times has increased.

Meanwhile, a representative example of the secondary battery may include a lithium ion secondary battery. The lithium ion secondary battery can be manufactured smaller and lighter and can stably supply power for a long period of time, due to high energy density; however, may reduce instant output and require long charging time due to low power density and shorten lifespan by several thousand times due to the charging/discharging.

A device referred to as an ultracapacitor or a supercapacitor that has been recently issued in order to supplement limitations of the above-mentioned lithium ion secondary battery has rapid charging and discharging speed, high stability, and environment-friendly characteristics, such that it is prominent as a next-generation energy storage device.

The ultracapacitor or the supercapacitor has lower energy density than that of the lithium ion secondary battery, but has higher power density several ten to several hundred times and longer lifetime hundreds of thousands times and has faster charging/discharging speed enough to achieve complete charging within several seconds, as compared with the lithium ion secondary battery.

The cells, the secondary batteries, and the capacitors as described above, which are energy storages, are used to drive various electrical application products. Since each cell may supplies only low voltage of several volt, a module in which a plurality of cells are connected to each other in series is requisite in order for each cell to be used as energy source for devices requiring high voltage.

Also, when the unit cells connected to each other in series is used as the energy source, if each of the cells is non-uniformly operated, lifetime of a module is rapidly reduced and a situation in which the equipment is damaged due to overvoltage or the equipment is not normally operated due to low voltage may occur. Therefore, a need exists for a member controlling the unit cells so that the unit cells may perform charging and discharging operation in a stable range.

### SUMMARY OF THE INVENTION

An object of the present invention is to provide an apparatus for stabilizing voltage of an energy storage capable of stably equalizing voltage of each unit cell and reusing voltage provided to the bypass path by providing a bypass path when voltage exceeding predetermined voltage is detected in each of the plurality of unit cells, thereby performing the voltage equalization without loss.

According to an exemplary embodiment of the present invention, there is provided an apparatus for stabilizing voltage of an energy storage in which a plurality of unit cells are connected to each other in series, including: a bypass unit that is connected to the unit cell in parallel; and a controller that detects voltage of the unit cell and controls an operation of the bypass unit according to the detected voltage of the unit cell, wherein the bypass unit bypasses current flowing in the unit cell when the detected voltage of the unit cell is larger than predetermined reference voltage to generate a reusing voltage.

The bypass unit may include: a switching unit that is connected to the unit cell in parallel and bypasses the current flowing in the unit cell when the voltage of the unit cell is larger than the reference voltage; and a reusing voltage generator that is connected to the switching unit in series and uses the bypassed current to generate the reusing voltage.

The switching unit may include a first switch of which one end is connected to one end of the unit cell and the other end is connected to the reusing voltage generator.

The controller may connect the switching unit when the detected voltage of the unit cell is larger than the reference voltage.

The reusing voltage generator may use the bypassed current to generate the reusing voltage when the current flowing in the unit cell is bypassed by connecting with the switching unit.

The reusing voltage generator may be a DC/DC converter that converts a level of applied voltage.

The reusing voltage generator may use the generated reusing voltage as a power supply for driving a load.

The load may be a cooling device.

The controller may include: a voltage detector that is connected to the unit cell in parallel; and a control signal generator that is connected to the bypass unit to output an operation control signal for operating the bypass unit when the detected voltage of the unit cell is larger than the reference voltage.

The reusing voltage generator may include: an inductor that boosts the applied voltage to a predetermined level; a rectifier that is connected to the inductor in series; a second switch that applies or interrupts the boosted voltage to an output element according to the switch control signal output from the controller; and an output element that outputs the voltage applied from the second switch.

### BRIEF DESCRIPTION OF THE DRAWINGS

FIG. 1 is a configuration diagram of an apparatus for stabilizing voltage of an energy storage according an exemplary embodiment of the present invention.

FIG. 2 is a detailed configuration diagram of an apparatus for stabilizing voltage of an energy storage shown in FIG. 1.

FIG. 3 is a circuit configuration diagram of a reusing voltage generator according to an exemplary embodiment of the present invention.

FIG. 4 is a circuit configuration diagram of a reusing voltage generator according to another exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

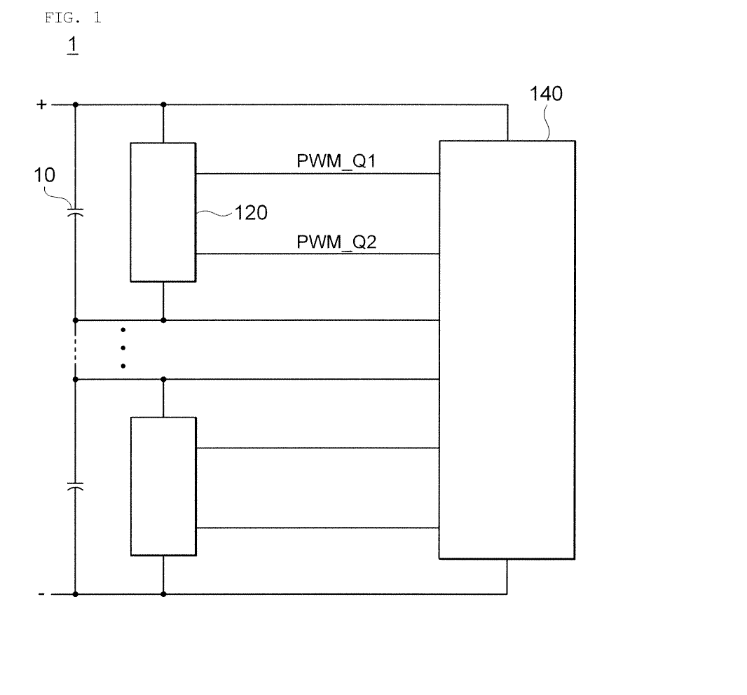

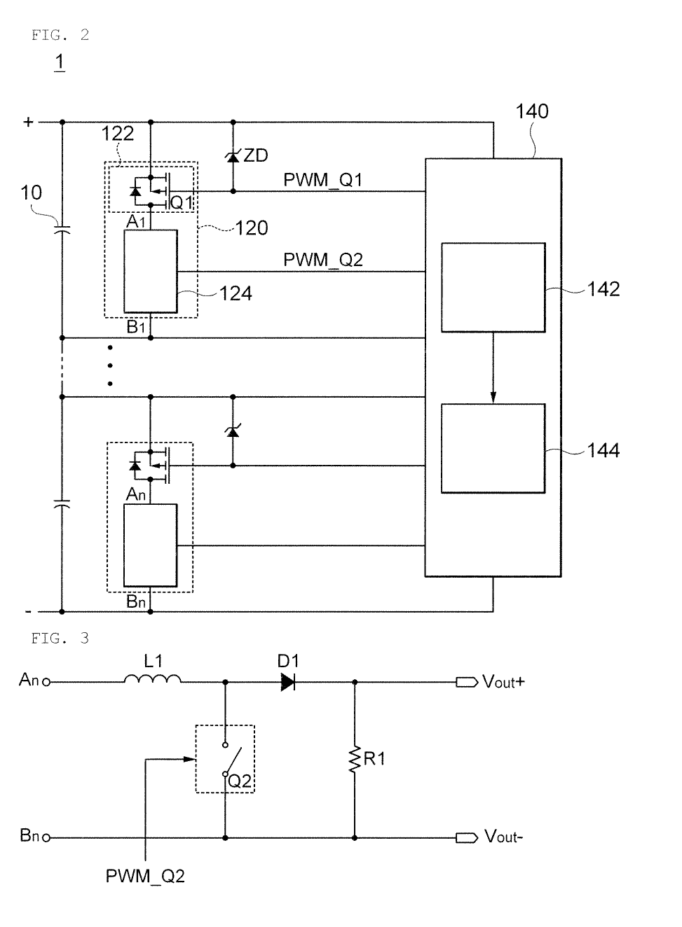

FIG. 1 is a configuration diagram of an apparatus for stabilizing voltage of an energy storage according an exemplary embodiment of the present invention and FIG. 2 is a detailed configuration diagram of an apparatus for stabilizing voltage of an energy storage shown in FIG. 1.

As shown in FIGS. 1 and 2, an apparatus 1 for stabilizing voltage of an energy storage is configured to include a bypass unit 120 and a controller 140 that transmits plurality of control signals PWM_Q1 and PWM_Q2 to the bypass unit 120.

First, briefly describing the energy storage, the energy storage means an apparatus in which a plurality of unit cells 10 (10a to 10n) are connected to each other in series so as to obtain high voltage. The unit cell 10 may be a unit cell of a secondary battery, an ultracapacitor, and a supercapacitor and a unit cell of the energy storage having other similar characteristics.

Hereinafter, the apparatus for stabilizing voltage of an energy storage will be described in detail.

The bypass unit 120 is connected with each of the plurality of unit cells 10 (10a to 10n) in parallel to bypass current flowing in the unit cell 10 when voltage exceeding predetermined voltage is applied to the unit cell 10, thereby generating reusing voltage.

That is, the bypass unit 120 bypasses the current flowing in the unit cell 10 to generate the reusing voltage when the voltage of the unit cell 10 is larger than reference voltage Vref.

In more detail, the bypass unit 120 includes a switching unit 122 and a reusing voltage generator 124. The switching unit 122 is connected with the plurality of unit cells 10a to 10n in parallel to bypass the current flowing in the unit cell 10 when the voltage of the unit cell 10 is larger than the reference voltage Vref, thereby preventing excessive current from being supplied to the unit cell 10.

In addition, the switching unit 122 may be simply implemented using the general bypass circuit with which a first switch Q1 is connected in series and one end of the first switch Q1 is connected to one end of the unit cell 10 and the other thereof is connected to the reusing voltage generator 124. When the first switch Q1 is closed (ON) by an operation control signal output from the controller 140, the current flowing in the unit cell 10 is reduced without increasing the voltage of the unit cell 10 any more while flowing in the first switch Q1.

The reusing voltage generator 124 is connected with the switching unit 122 in series and the first switch (Q1) is closed (ON) to generate the reusing current using the bypassed current when the current flowing in the unit cell 10 is bypassed.

In more detail, when the first switch Q1 is closed (ON) to move the current flowing in the unit cell 10 to the first switch Q1, the reusing voltage generator 124 generates the reusing voltage using the current flowing in the first switch Q1 to generate the reusing voltage and is directly or indirectly connected to a load 20 or other devices to use the reusing voltage as a power supply in the load 20 or other devices.

In this configuration, the reusing voltage generator 124 may be configured of a DC/DC converter that can convert a level of applied voltage. In particular, among the DC/DC converter, the reusing voltage generator 124 is configured of a boost converter to generate the stabilized output voltage.

Hereinafter, the reusing voltage generator 124 configured of the boost converter will be described in more detail.

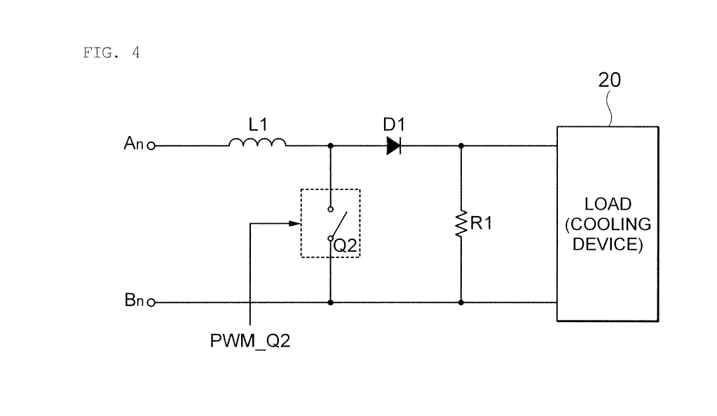

FIG. 3 is a circuit configuration diagram of a reusing voltage generator according to an exemplary embodiment of the present invention and FIG. 4 is a circuit configuration diagram of a reusing voltage generator according to another exemplary embodiment of the present invention.

Referring to FIGS. 3 and 4, the boost converter, which is one of circuits generally representing the DC/DC converter, boosts the input voltage to generate the stabilized output voltage. The boost converter may be referred to as the boost type converter and may be used only when a ground GND of the input end and the output end is the same.

Further, the boost converter is referred to as a current-fed manner since the situation in which the flow of current in loads is periodically interrupted is repeated in the viewpoint of a load side. In this case, since the current of the output end is always smaller than the input end and the loss component is not present in the operating principle of the circuit, it can be appreciated from a relationship equation of input current input voltage=output current output voltage that the output voltage is always higher than the input voltage.

Meanwhile, the boost converter includes an inductor L1, a rectifier D1, a second switch Q2, and an output element R1.

The inductor L1 boosts the applied DC voltage (voltage applied to A and B terminals) to a predetermined level, the rectifier D1 is a unit that prevents current corresponding to DC voltage from reflowing and is configured of diodes and is connected with the inductor L1 in series.

Further, a cathode end that is an output of the diode D1 is connected with the load 20 to which output voltage Vout is applied.

The second switch Q2 is connected between the inductor L1 and the rectifying element D1 in parallel and applies or interrupts the voltage boosted according to a switch control signal PWM_Q2 output from the controller 140 to the output element R1.

In more detail, when the second switch Q2 is closed by current applied thereto, the current changing in response to the switch control signal PWM_Q2, that is, gate control voltage V_{G}, the DC voltage is connected to both ends of the inductor L1 while the second switch Q2 is connected, such that the voltage charging is performed, the current of the inductor L1 flows in a drain D end of the second switch Q2 to flow to a source (S) end.

The second switching element Q2 is closed by current applied thereto, the current changing in response to the switch control signal PWM_Q2, that is, gate control voltage V. In this case, when the second switching element Q2 is turned-on, the DC voltage is connected to both ends of the inductor L1 while the second switch Q2 is turned-on, such that the voltage charging is performed, thereby moving the current of the inductor L1 to a drain D end of the second switch Q2 to be flow in a source (S) end.

When the second switch Q2 is opened (OFF), the voltage charged in the inductor L1 is transferred to the output element R1 via the rectifier D1 to be applied to the load. The second switch Q2 is a switching element through which large current may flow and may be configured of a bipolar junction transistor (BJT), an insulated gate bipolar transistor (IGBT), a metal-oxide-semiconductor field effect transistor (MOSFET), or the like.

The output element R1 discharges DC voltage boosted in the inductor L1 to be output.

Referring back to FIGS. 1 and 2, the controller 140, which is a unit generally controlling the apparatus 1 for stabilizing voltage of an energy storage, is connected to both ends of all the unit cells 10a to 10n.

The controller 140 is configured to include the voltage detector 142 and the control signal generator 144.

The voltage detector 142 detects both ends of the unit cell 10 to detect the voltage of each unit cell 10.

The control signal generator 144 monitors the voltage of each unit cell 10 detected in the voltage detector 142 to output the operation control signal PWM_Q1 for operating the bypass unit 120 when the voltage of the unit cell is larger than the predetermined reference voltage Vref.

In more detail, the control signal generator 144 generates the operation control signal PWM_Q1 for closing (ON) the switching unit 122 so as to be transmitted to the switching unit 122 when the detected voltage of the unit cell 10 is larger than the predetermined reference voltage Vref, thereby reducing the voltage of the unit cell 10 having a voltage level higher than a predetermined level.

The controller 140 may include a storage unit such as a memory for storing data such as the detected voltage of the unit cell 10 and the reference voltage, or the like, and a processor for performing various control instructions and calculations.

Meanwhile, the control signal generator 144 generates the switch control signal PWM_Q2 for closing (ON) or opening (OFF) the second switch Q2 of the reusing voltage generator 124 to be provided to the second switch Q2.

As described above, the controller 140 is performed in a method of continuously detecting and monitoring the voltage of the unit cell 10 and reducing the voltage of the corresponding unit cell 10 to be the reference voltage Vref or less by operating the switching unit 122 when the detected or monitored voltage of each unit cell 10 is larger than the reference voltage Vref.

When the voltage of each unit cell 10 is equal to or less than the reference voltage Vref, the controller 140 stops the operation control signal PWM_Q1 applied to the switching unit 122, thereby stopping the bypass.

Further, the reusing voltage generator 124 uses the bypassed current in the switching unit 122 to generate the reusing voltage to be used as a power supply. That is, the reusing voltage generator 124 may be connected to the device requiring the driving voltage (energy) so as to use the reusing voltage or may be directly connected to the load 20 to drive the load 20.

In particular, the problem of causing the deterioration due to the heat generation by cooling heat generated from the unit cell 10 using the reusing voltage as a power supply driving a cooling device, that is, a fan among the driving devices can be improved.

As described above, the reason of driving the fan using the reusing voltage is that the apparatus 1 for stabilizing voltage of an energy storage is always operated at the time of the fast charging and discharging and in the idle period when the charging/discharging stop. As a result, when temperature is increased to a predetermined temperature due to the heat generation from the unit cell 10, gas is generated therein, such that the deterioration is progressed.

Therefore, the apparatus for stabilizing voltage of an energy storage according to the exemplary embodiment of the present invention stably equalizes the voltage in each unit cell and reuse the voltage provided to the bypass path by providing the bypass path when the voltage exceeding the predetermined voltage is detected in each unit cell, thereby effectively perform the voltage equalization without loss.

As set forth above, the apparatus for stabilizing voltage of an energy storage according to the exemplary embodiment of the present invention can stably equalize the voltage of each unit cell and reuse voltage provided to the bypass path by providing a bypass path when voltage exceeding predetermined voltage is detected in each of the plurality of unit cells, thereby performing the voltage equalization without loss.

In addition, the apparatus for stabilizing voltage of an energy storage according to the exemplary embodiment of the present invention can use the voltage provided to the bypass path as the power supply for driving loads. In particular, when the apparatus for stabilizing voltage of an energy storage is used for driving the cooling device, that is, the fan, it can cool heat generated from each unit cell to improve the deterioration due to the heat generation.

In addition, the apparatus for stabilizing voltage of an energy storage according to the exemplary embodiment of the present invention adopts the method of reusing the voltage provided to the bypass path as the power supply for driving loads, such that it does not give stress to electronic parts, thereby improving the reliability.

Finally, the apparatus for stabilizing voltage of an energy storage according to the exemplary embodiment of the present invention can reuse energy that may be acted as loss, thereby increasing the energy efficiency.

Although the exemplary embodiments of the present invention have been described, it will be apparent to those skilled in the art that various modifications and variations can be made in the present invention without departing from the spirit or scope of the inventions.

What is claimed is:

1. An apparatus for stabilizing voltage of an energy storage in which a plurality of unit cells are connected to each other in series, comprising:
a bypass unit that is connected to the unit cell in parallel; and
a controller that detects voltage of the unit cell and controls an operation of the bypass unit according to the detected voltage of the unit cell,
wherein the bypass unit bypasses current flowing in the unit cell when the detected voltage of the unit cell is larger than predetermined reference voltage to generate a reusing voltage.

2. The apparatus according to claim 1, wherein the bypass unit includes:
a switching unit that is connected to the unit cell in parallel and bypasses the current flowing in the unit cell when the detected voltage of the unit cell is larger than the reference voltage; and
a reusing voltage generator that is connected to the switching unit in series and uses the bypassed current to generate the reusing voltage.

3. The apparatus according to claim 2, wherein the switching unit includes a first switch of which one end is connected to one end of the unit cell and the other end is connected to the reusing voltage generator.

4. The apparatus according to claim 2, wherein the controller connects the switching unit when the detected voltage of the unit cell is larger than the reference voltage.

5. The apparatus according to claim 4, wherein the reusing voltage generator uses the bypassed current to generate the reusing voltage when the current flowing in the unit cell is bypassed by connecting with the switching unit.

6. The apparatus according to claim 2, wherein the reusing voltage generator is a DC/DC converter that converts a level of applied voltage.

7. The apparatus according to claim 2, wherein the reusing voltage generator uses the generated reusing voltage as a power supply for driving a load.

8. The apparatus according to claim 7, wherein the load is a cooling device.

9. The apparatus according to claim 1, wherein the controller includes:
a voltage detector that is connected to the unit cell in parallel; and
a control signal generator that is connected to the bypass unit to output an operation control signal for operating the bypass unit when the detected voltage of the unit cell is larger than the reference voltage.

10. The apparatus according to claim 2, wherein the reusing voltage generator includes:
an inductor that boosts the applied voltage to a predetermined level
a rectifier that is connected to the inductor in series;
a second switch that applies or interrupts the boosted voltage to an output element according to the switch control signal output from the controller; and
an output element that outputs the voltage applied from the second switch.
